(19) United States
(12) Patent Application Publication
(10) Pub. No.: US 2026/0237788 A1
(43) Pub. Date: Aug. 13, 2026

(54) COOLING ASSEMBLY FOR BATTERY SYSTEM

(71) Applicant: Caterpillar Inc., Peoria, IL (US)

(72) Inventors: Jayneel Harish Pandya, Oro Valley, AZ (US); Cameron Thomas Lane, Oro Valley, AZ (US)

(73) Assignee: Caterpillar Inc., Peoria, IL (US)

(21) Appl. No.: 19/050,329

(22) Filed: Feb. 11, 2025

(51) Int. Cl. H01M 10/6566; H01M 10/613; H01M 10/6556

(52) U.S. Cl. CPC H01M 10/6566; H01M 10/613; H01M 10/6556

(57) ABSTRACT

A cooling assembly includes a number of cooling manifolds in fluid communication with a battery module, an inlet channel for allowing ingress of a cooling fluid, an inlet manifold fluidly coupled with the inlet channel, a number of inlet tubes fluidly communicates the inlet manifold with a corresponding cooling manifold. A first inlet end of each inlet tube is coupled to the inlet manifold and a second inlet end of each inlet tube is coupled to the corresponding cooling manifold. The cooling assembly also includes an outlet channel for allowing egress of the cooling fluid, an outlet manifold fluidly coupled with the outlet channel, a number of outlet tubes fluidly communicates the corresponding cooling manifold with the outlet manifold. A first outlet end of each outlet tube is coupled to the outlet manifold and a second outlet end of each outlet tube is coupled to the corresponding cooling manifold.

### TECHNICAL FIELD

The present disclosure relates to a battery system, and more particularly, to a cooling assembly for the battery system.

### BACKGROUND

Battery systems are widely used in a variety of applications as a means of power supply. For example, battery systems are being increasingly implemented in stationary and mobile machines, such as machines, passenger vehicles, construction machines, and the like, to provide power supply to one or more components. The battery system includes one or more battery modules which vary in configuration based on power supply requirements. In order to perform efficiently, the battery modules of the battery systems may have to be maintained and operated within predefined temperature limits to prevent overheating of the battery modules. The battery systems have a cooling assembly that supplies a cooling fluid to maintain a temperature of the number of battery modules of the battery system within the predefined temperature limits.

Conventional cooling assemblies include a high number of coolant hoses that fluidly couple a cooling manifold with individual battery modules. A number of such cooling hoses increases as a size of the battery system increases, with some battery systems having hundreds of such cooling hoses. Such cooling hoses may be susceptible to assembly variation and may also be vulnerable to thermal runaway events. Particularly, the cooling hoses may melt during a release of thermal gases during thermal runaway events, thereby causing undesirable coolant leaks. Further, the cooling hoses are susceptible to wear over time and the design of conventional cooling hoses have a higher potential to develop leaks over time.

U.S. Pat. No. 7,846,573 describes a battery assembly may include a cooling system assembly having first and second battery modules and a coolant manifold in fluid communication therewith. The first battery module may include a first coolant flow path and the second battery module may include a second coolant flow path. The coolant manifold may include first and second ports and a main body portion to provide expansion and contraction between the first and second ports. The first port may be in communication with the first flow path and the second port may be in communication with the second flow path.

### SUMMARY OF THE DISCLOSURE

In an aspect of the present disclosure, a cooling assembly for a battery system is provided. The battery system includes a plurality of battery modules. The cooling assembly includes a plurality of cooling manifolds. Each cooling manifold from the plurality of cooling manifolds is in fluid communication with a corresponding battery module from the plurality of battery modules. The cooling assembly also includes an inlet channel for allowing ingress of a cooling fluid into the cooling assembly. The cooling assembly further includes an inlet manifold fluidly coupled with the inlet channel and extending along a vertical axis of the battery system. The cooling assembly includes a plurality of inlet tubes. Each inlet tube from the plurality of inlet tubes fluidly communicates the inlet manifold with a corresponding cooling manifold from the plurality of cooling manifolds. Each inlet tube defines a first inlet end and a second inlet end. The first inlet end of each inlet tube is coupled to the inlet manifold and the second inlet end of each inlet tube is coupled to the corresponding cooling manifold. The cooling assembly also includes an outlet channel for allowing egress of the cooling fluid from the cooling assembly. The cooling assembly further includes an outlet manifold fluidly coupled with the outlet channel and extending along the vertical axis of the battery system. The cooling assembly includes a plurality of outlet tubes. Each outlet tube from the plurality of outlet tubes fluidly communicates the corresponding cooling manifold with the outlet manifold. Each outlet tube defines a first outlet end and a second outlet end. The first outlet end of each outlet tube is coupled to the outlet manifold and the second outlet end of each outlet tube is coupled to the corresponding cooling manifold.

In another aspect of the present disclosure, a battery system is provided. The battery system includes a plurality of battery modules. The battery system also includes a cooling assembly to direct cooling fluid towards the plurality of battery modules. The cooling assembly includes a plurality of cooling manifolds. Each cooling manifold from the plurality of cooling manifolds is in fluid communication with a corresponding battery module from the plurality of battery modules. The cooling assembly also includes an inlet channel for allowing ingress of the cooling fluid into the cooling assembly. The cooling assembly further includes an inlet manifold fluidly coupled with the inlet channel and extending along a vertical axis of the battery system. The cooling assembly includes a plurality of inlet tubes. Each inlet tube from the plurality of inlet tubes fluidly communicates the inlet manifold with a corresponding cooling manifold from the plurality of cooling manifolds. Each inlet tube defines a first inlet end and a second inlet end. The first inlet end of each inlet tube is coupled to the inlet manifold and the second inlet end of each inlet tube is coupled to the corresponding cooling manifold. The cooling assembly also includes an outlet channel for allowing egress of the cooling fluid from the cooling assembly. The cooling assembly further includes an outlet manifold fluidly coupled with the outlet channel and extending along the vertical axis of the battery system. The cooling assembly includes a plurality of outlet tubes. Each outlet tube from the plurality of outlet tubes fluidly communicates the corresponding cooling manifold with the outlet manifold. Each outlet tube defines a first outlet end and a second outlet end. The first outlet end of each outlet tube is coupled to the outlet manifold and the second outlet end of each outlet tube is coupled to the corresponding cooling manifold.

Other features and aspects of this disclosure will be apparent from the following description and the accompanying drawings.

### BRIEF DESCRIPTION OF THE DRAWINGS

FIG. 1 is a schematic front view of a battery system, according to an example of the present disclosure;

FIG. 2 is a schematic perspective view of a battery module associated with the battery system of FIG. 1;

FIG. 3 is a schematic sectional view illustrating a portion of a cooling assembly associated with the battery system of FIG. 1.

FIG. 4 is a schematic perspective view of a battery system, according to another example of the present disclosure;

FIG. 5 is a schematic perspective view of a battery module associated with the battery system of FIG. 4;

FIG. 6 is a schematic sectional view illustrating a portion of a cooling assembly associated with the battery system of FIG. 4.

FIG. 7 is a schematic perspective view of a battery system, according to yet another example of the present disclosure;

FIG. 8 is a schematic perspective view of a battery module associated with the battery system of FIG. 7;

FIG. 9 is a schematic sectional view illustrating a portion of a cooling assembly associated with the battery system of FIG. 7.

FIG. 10 is a schematic perspective view of a battery system, according to yet another example of the present disclosure;

FIG. 11 is a schematic perspective view of a battery module associated with the battery system of FIG. 10; and

FIG. 12 is a schematic sectional view illustrating a portion of a cooling assembly associated with the battery system of FIG. 10.

### DETAILED DESCRIPTION

Wherever possible, the same reference numbers will be used throughout the drawings to refer to the same or like parts.

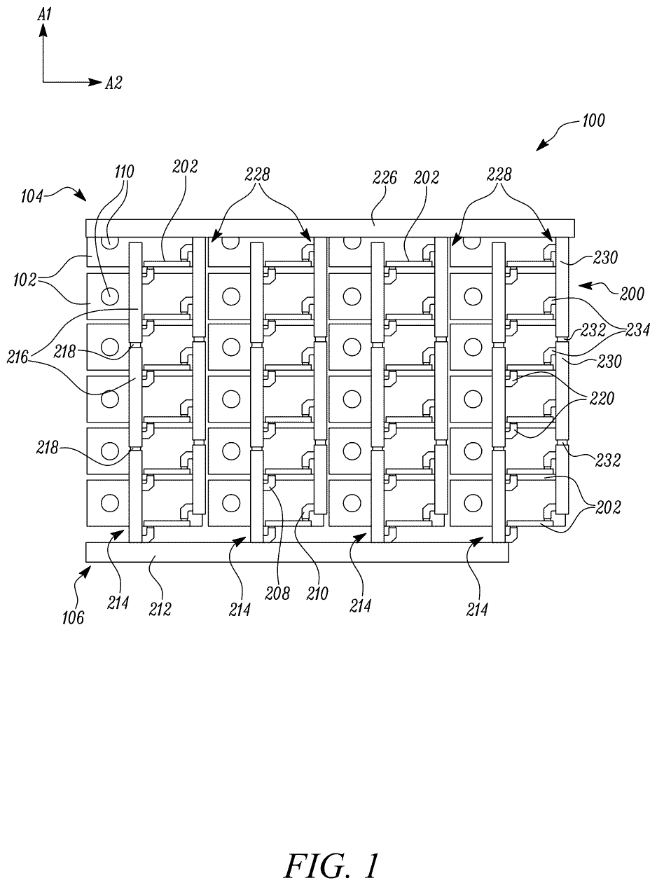

Referring to FIG. 1, a schematic view of a battery system 100 is illustrated. In some examples, the battery system 100 may be used in energy storage systems. In an example, the battery system 100 may supply electrical power to a moving machine, such as a work/construction machine, or a stationary machine. The battery system 100 defines a top end 104 and a bottom end 106 opposite to the top end 104. The battery system 100 defines a vertical axis A1 and a horizontal axis A2. The battery system 100 extends along the vertical axis A1 and the horizontal axis A2.

The battery system 100 includes a number of battery modules 102. The number of battery modules 102 are stacked on each other in a row along the vertical axis A1 of the battery system 100. The rows of the battery modules 102 are disposed adjacent to each other along the horizontal axis A2 of the battery system 100. The battery modules 102 are electrically coupled together in a stacked relationship to provide a desired amount of power output and voltage output.

In the illustrated example of FIG. 1, each row of the battery modules 102 includes six battery modules 102. In some examples, each row of the battery modules 102 may include seven battery modules 102, eight battery modules 102, nine battery modules 102, and so on, without limiting the scope of present disclosure. It should be noted that a configuration of the battery system 100 as explained herein is exemplary in nature, and the battery system 100 may include any number of rows of the battery modules 102, based on application requirements. The present disclosure is not limited to the number of rows and the number of battery modules 102 in each row.

Each battery module 102 may include a number of rechargeable lithium-ion cells to store electric power and distribute the stored electric power at a desired voltage and a desired amperage for desired applications. In other examples, each battery module 102 may include a number of rechargeable lead-acid cells, nickel metal hydride (NiMH) cells, a number of pocket cells, and the like that converts chemical energy to electrical energy.

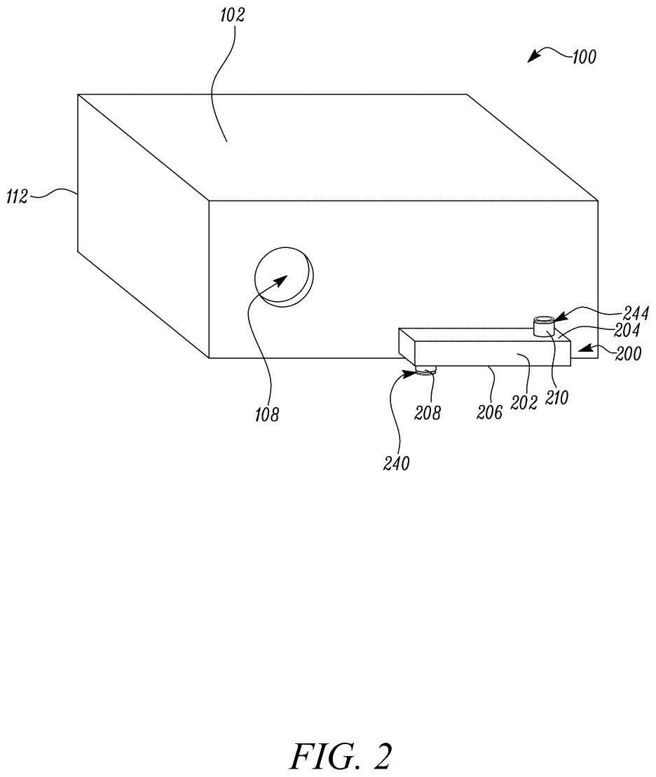

Each battery module 102 defines a vent portion 108 (shown in FIG. 2) defined in a housing 112 (shown in FIG. 2) of the battery module 102. The vent portion 108 is an outlet for thermal runaway gases that may generate during a thermal event in the battery module 102. The vent portion 108 directs the thermal runaway gases towards atmosphere. The thermal runaway gases that are released from the battery modules 102 include a mixture of hot gases and hot liquid particles, for example.

Each of the number of battery modules 102 further includes a burst disc 110. The burst disc 110 encloses the vent portion 108 in the housing 112 of a corresponding battery module 102.

The battery system 100 also includes a cooling assembly 200 to direct a cooling fluid towards the number of battery modules 102. The cooling fluid may include water, a combination of water and one or more chemicals, a coolant, or any other type of cooling fluid. The cooling assembly 200 may be coupled to a thermal management system (not shown) of the battery system 100 to maintain a temperature of the battery system 100 within desired operating limits. The thermal management system may include, for example, a pump, a fluid reservoir, valves, a controller, and the like.

Further, the cooling assembly 200 includes a number of cooling manifolds 202. Each cooling manifold 202 from the number of cooling manifolds 202 is in fluid communication with a corresponding battery module 102 from the number of battery modules 102. The cooling manifold 202 is fixedly coupled with the corresponding battery module 102. The cooling manifold 202 has a rectangular shaped design. The cooling manifold 202 acts as a fluid path between the cooling assembly 200 and the corresponding battery module 102. The cooling manifold 202 may be manufactured by a casting process or the cooling manifold 202 may be fabricated using any known technique.

Referring to FIG. 2 a schematic perspective view of the cooling manifold 202 is illustrated. The cooling manifold 202 defines a top surface 204 and a bottom surface 206. The cooling assembly 200 includes a number of inlet connectors 208. Each inlet connector 208 from the number of inlet connectors 208 is fixedly coupled to an inlet manifold 214 and/or the corresponding cooling manifold 202. In the illustrated example of FIG. 2, each inlet connector 208 is fixedly coupled with the corresponding cooling manifold 202. In some examples, each inlet connector 208 may be integral with the corresponding cooling manifold 202. In other examples, each inlet connector 208 may be fixedly coupled with the cooling manifold 202 by welding, soldering, brazing, and the like. Further, in the illustrated example of FIG. 2, each inlet connector 208 defines an O-ring groove 240. In other examples, the O-ring groove 240 can be a part of the inlet manifold 214.

The cooling assembly 200 further includes a number of outlet connectors 210. Each outlet connector 210 from the number of outlet connectors 210 is fixedly coupled to an outlet manifold 228 and/or the corresponding cooling manifold 202. In the illustrated example of FIG. 2, each outlet connector 210 is fixedly coupled with the corresponding cooling manifold 202. In some examples, each outlet connector 210 may be integral with the corresponding cooling manifold 202. In other examples, each outlet connector 210 may be fixedly coupled with the cooling manifold 202 by welding, soldering, brazing, and the like. Further, in the illustrated example of FIG. 2, each outlet connector 210 defines an O-ring groove 244. In other examples, the O-ring groove 244 can be a part of the outlet manifold 228.

In the illustrated example of FIG. 2, the inlet connector 208 is disposed at the bottom surface 206 of the cooling manifold 202 and the outlet connector 210 is disposed at the top surface 204 of the cooling manifold 202. In another example, the inlet connector 208 may be disposed at the top surface 204 and the outlet connector 210 may be disposed at the bottom surface 206 of the cooling manifold 202. In other examples, each of the inlet connector 208 and the outlet connector 210 may be disposed at the top surface 204 of the cooling manifold 202 or each of the inlet connector 208 and the outlet connector 210 may be disposed at the bottom surface 206 of the cooling manifold 202.

In some examples, the inlet connector 208 and the outlet connector 210 may be integral with the cooling manifold 202. In other examples, the inlet connector 208 and the outlet connector 210 may be fixedly coupled with the cooling manifold 202 by welding, soldering, brazing, and the like. The inlet connector 208 and the outlet connector 210 are embodied as tubular members herein.

Referring again to FIG. 1, the cooling assembly 200 also includes an inlet channel 212 for allowing ingress of the cooling fluid into the cooling assembly 200. In the illustrated example of FIG. 1, the inlet channel 212 is disposed proximal to the bottom end 106 of the battery system 100. The inlet channel 212 extends along the horizontal axis A2. The inlet channel 212 may include a single piece design or the inlet channel 212 may include a number of channel portions that are coupled with each other using suitable connectors.

The cooling assembly 200 further includes the inlet manifold 214 fluidly coupled with the inlet channel 212. Specifically, the inlet manifold 214 is fluidly coupled with the inlet channel 212 at one end and is capped at another end. The inlet channel 212 extends along the vertical axis A1 of the battery system 100. The inlet manifold 214 includes a number of inlet manifold portions 216 and a number of inlet coupling portions 218. Each inlet coupling portion 218 connects two inlet manifold portions 216 with each other. The inner coupling portion 218 receives two individual ends of the two inlet manifold portions 216 with seals on each end that allows connection of the two inlet manifold portions 216 with each other.

In the illustrated example of FIG. 1, the inlet manifold 214 includes four inlet manifolds 214. In another example, the inlet manifold 214 may include three inlet manifolds 214, five inlet manifolds 214, six inlet manifolds 214, and so on, based on the number of rows associated of the battery modules 102 with the battery system 100. In the illustrated example of FIG. 1, each inlet manifold 214 includes three inlet manifold portions 216 and two inlet coupling portions 218. Further, a total number of the inlet manifold portions 216 and the inlet coupling portions 218 may vary depending on the number of battery modules 102 of the battery system 100. Furthermore, the required number of the inlet manifold portions 216 and the inlet coupling portions 218 are in a ratio of M:M−1, where M is the number of the inlet manifold portions 216.

The cooling assembly 200 also includes an outlet channel 226 for allowing egress of the cooling fluid from the cooling assembly 200. The outlet channel 226 extends along the horizontal axis A2. The outlet channel 226 may include a single piece design or the outlet channel 226 may include a number of channel portions that are coupled with each other using suitable connectors.

In the illustrated example of FIG. 1, the outlet channel 226 is disposed proximal to the top end 104 of the battery system 100. In another example, the inlet channel 212 may be disposed proximally to the top end 104 of the battery system 100 and the outlet channel 226 may be disposed proximal to the bottom end 106 of the battery system 100.

The cooling assembly 200 further includes the outlet manifold 228 fluidly coupled with the outlet channel 226. Specifically, the outlet manifold 228 is fluidly coupled with the outlet channel 226 at one end and is capped at another end. The outlet manifold 228 extends along the vertical axis A1 of the battery system 100. The outlet manifold 228 includes a number of outlet manifold portions 230 and a number of outlet coupling portions 232. Each outlet coupling portion 232 connects two outlet manifold portions 230 with each other. The outlet coupling portion 232 receives two individual ends of the two outlet manifold portions 230 with seals on each end that allows connection of the two outlet manifold portions 230 with each other.

In the illustrated example of FIG. 1, the outlet manifold 228 includes four outlet manifolds 228. In another example, the outlet manifold 228 may include three outlet manifolds 228, five outlet manifolds 228, six outlet manifolds 228, and so on, based on the number of rows of the battery modules 102 associated with the battery system 100. In the illustrated example of FIG. 1, each outlet manifold 228 includes three outlet manifold portions 230 and two outlet coupling portions 232. Further, a total number of the outlet manifold portions 230 and the outlet coupling portions 232 may vary depending on the number of battery modules 102 of the battery system 100. Furthermore, the required number of the outlet manifold portions 230 and the outlet coupling portions 232 in the cooling assembly 200 are in a ratio of N:N−1, where N is the number of the outlet manifold portions 230.

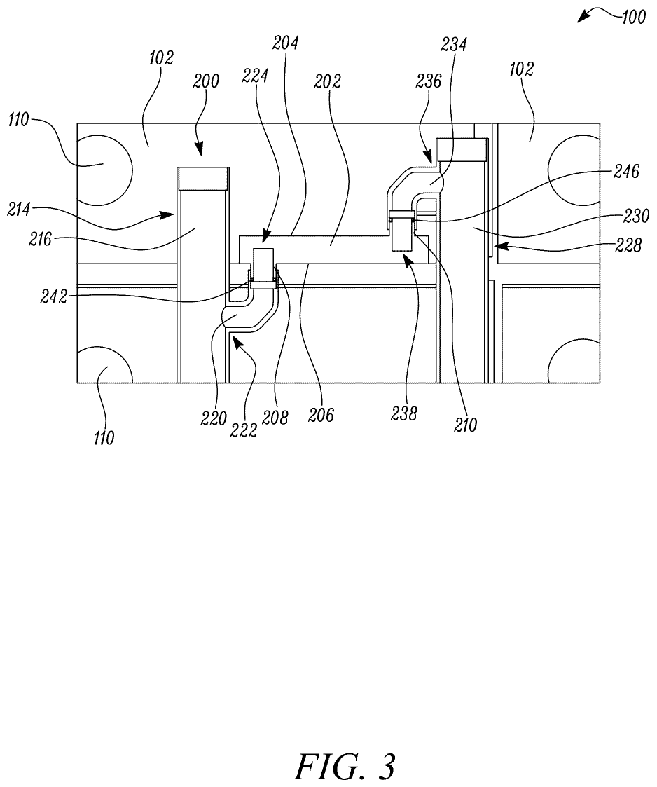

Referring now to FIGS. 1 and 3, the cooling assembly 200 further includes a number of inlet tubes 220. Each inlet tube 220 from the number of inlet tubes 220 fluidly communicates the inlet manifold 214 with the corresponding cooling manifold 202 from the number of cooling manifolds 202. Each inlet tube 220 has an elbow chape.

Each inlet tube 220 defines a first inlet end 222. The first inlet end 222 of each inlet tube 220 is coupled to the inlet manifold 214. In the illustrated example of FIGS. 1 and 3, the first inlet end 222 of each inlet tube 220 is fixedly coupled to the inlet manifold 214. In an example, the inlet tube 220 may be integral with the inlet manifold 214 or the inlet tube 220 may be fixedly coupled to the inlet manifold 214 via welding, brazing, soldering, and the like.

Further, each inlet tube 220 also defines a second inlet end 224. The second inlet end 224 of each inlet tube 220 is coupled to the corresponding cooling manifold 202. In the illustrated example of FIGS. 1 and 3, the second inlet end 224 of each inlet tube 220 is removably coupled to the corresponding cooling manifold 202. Specifically, the second inlet end 224 of each inlet tube 220 is removably coupled to the corresponding cooling manifold 202 via the inlet connector 208. Each inlet connector 208 is removably coupled with a corresponding inlet tube 220 from the number of inlet tubes 220 to removably couple the corresponding inlet tube 220 with the inlet manifold 214 and/or the corresponding cooling manifold 202. Particularly, in the illustrated example of FIGS. 1 and 3, the inlet connector 208 is removably coupled with the corresponding inlet tube 220 to removably couple the corresponding inlet tube 220 with the corresponding cooling manifold 202.

Further, each inlet connector 208 is removably coupled with the corresponding inlet tube 220 via a slip fit. Specifically, each inlet connector 208 is removably coupled with the corresponding inlet tube 220 via an O-ring slip joint. Further, an O-ring 242 is received within the O-ring groove 240 of the inlet connector 208 to seal a connection between the inlet tube 220 and the inlet connector 208. It should be noted that each inlet connector 208 may be removably coupled with the corresponding inlet tube 220 via any other type of fit. As illustrated herein, when coupled together, each inlet connector 208 is received within the corresponding inlet tube 220.

Furthermore, the second inlet end 224 of each inlet tube 220 is coupled to the corresponding cooling manifold 202 at the top surface 204 or the bottom surface 206. Particularly, in the illustrated example of FIGS. 1 and 3, the second inlet end 224 of each inlet tube 220 is coupled to the corresponding cooling manifold 202 at the bottom surface 206.

The cooling assembly 200 further includes a number of outlet tubes 234. Each outlet tube 234 from the number of outlet tubes 234 fluidly communicates the corresponding cooling manifold 202 with the outlet manifold 228. Each outlet tube 234 has an elbow chape.

Each outlet tube 234 defines a first outlet end 236. The first outlet end 236 of each outlet tube 234 is coupled to the outlet manifold 228. In the illustrated example of FIGS. 1 and 3, the first outlet end 236 of each outlet tube 234 is fixedly coupled to the outlet manifold 228. In an example, the outlet tube 234 may be integral with the outlet manifold 228 or the outlet tube 234 may be fixedly coupled to the outlet manifold 228 via welding, brazing, soldering, and the like.

Further, each outlet tube 234 also defines a second outlet end 238. The second outlet end 238 of each outlet tube 234 is coupled to the corresponding cooling manifold 202. In the illustrated example of FIGS. 1 and 3, the second outlet end 238 of each outlet tube 234 is removably coupled to the corresponding cooling manifold 202. Specifically, the second outlet end 238 of each outlet tube 234 is removably coupled to the corresponding cooling manifold 202 via the outlet connector 210. Each outlet connector 210 is removably coupled with a corresponding outlet tube 234 from the number of outlet tubes 234 to removably couple the corresponding outlet tube 234 with the outlet manifold 228 and/or the corresponding cooling manifold 202. In the illustrated example of FIGS. 1 and 3, the outlet connector 210 is removably coupled with the corresponding outlet tube 234 to removably couple the corresponding outlet tube 234 with the corresponding cooling manifold 202.

Further, each outlet connector 210 is removably coupled with the corresponding outlet tube 234 via a slip fit. Specifically, each outlet connector 210 is removably coupled with the corresponding outlet tube 234 via an O-ring slip joint. Further, an O-ring 246 is received within the O-ring groove 244 of the outlet connector 210 to seal a connection between the outlet tube 234 and the outlet connector 210. It should be noted that each outlet connector 210 may be removably coupled with the corresponding outlet tube 234 via any other type of fit. As illustrated herein, when coupled together, each outlet connector 210 is received within the corresponding outlet tube 234.

Furthermore, the second outlet end 238 of each outlet tube 234 is coupled to the corresponding cooling manifold 202 at the top surface 204 or the bottom surface 206. In the illustrated example of FIGS. 1 and 3, the second outlet end 238 of each outlet tube 234 is coupled to the corresponding cooling manifold 202 at the top surface 204.

As shown in FIG. 1, each of the inlet manifold 214, the number of inlet tubes 220, the outlet manifold 228, and the number of outlet tubes 234 are offset from the vent portion 108 (see FIG. 2) of each of the number of battery modules 102. Further, the inlet manifolds 214, the inlet tubes 220, the cooling manifolds 202, the outlet manifolds 228, and the outlet tubes 234 may be made from metals or alloys.

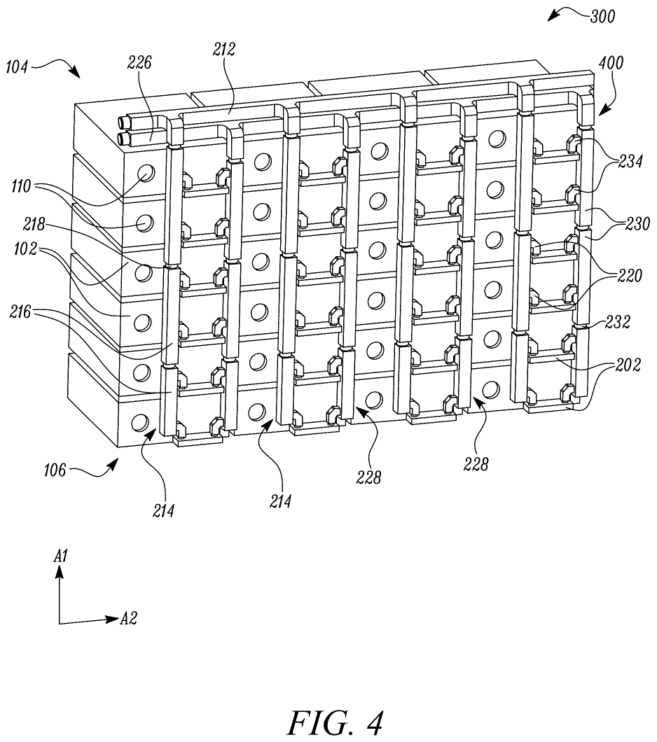

Referring to FIG. 4, a schematic perspective view of a battery system 300 is illustrated, according to another example of the present disclosure. The battery system 300 is substantially similar to the battery system 100 (see FIGS. 1 to 3), with common components being referred to by the same numerals. The battery system 300 includes a cooling assembly 400. The cooling assembly 400 is substantially similar to the cooling assembly 200 (see FIGS. 1 to 3), with common components being referred to by the same numerals. In the illustrated example of FIG. 4, each of the inlet channel 212 and the outlet channel 226 of the cooling assembly 400 is disposed proximal to the top end 104 of the battery system 300.

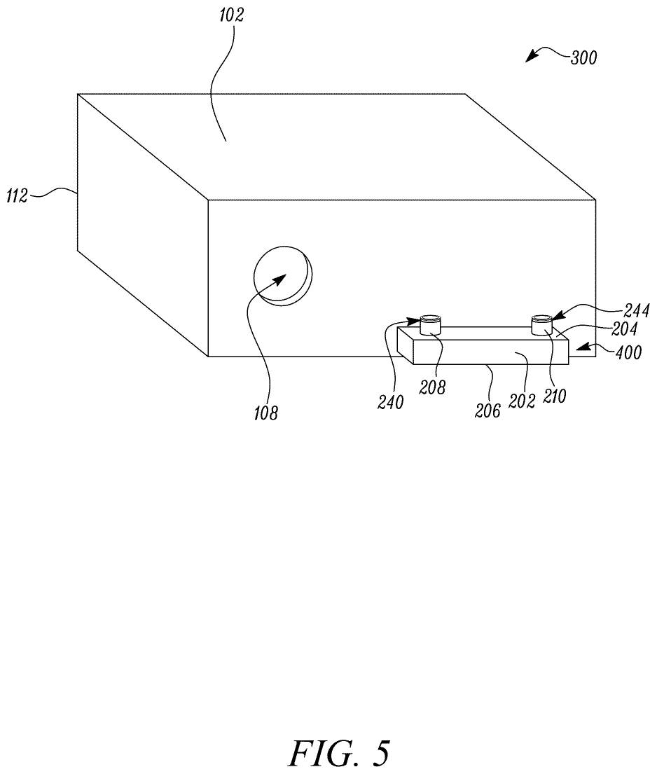

Referring now to FIGS. 4 and 5, the cooling assembly 400 includes the inlet connectors 208. In the illustrated example of FIGS. 4 and 5, each inlet connector 208 is fixedly coupled with the corresponding cooling manifold 202. The cooling assembly 400 further includes the outlet connectors 210. In the illustrated example of FIGS. 4 and 5, each outlet connector 210 is fixedly coupled with the corresponding cooling manifold 202.

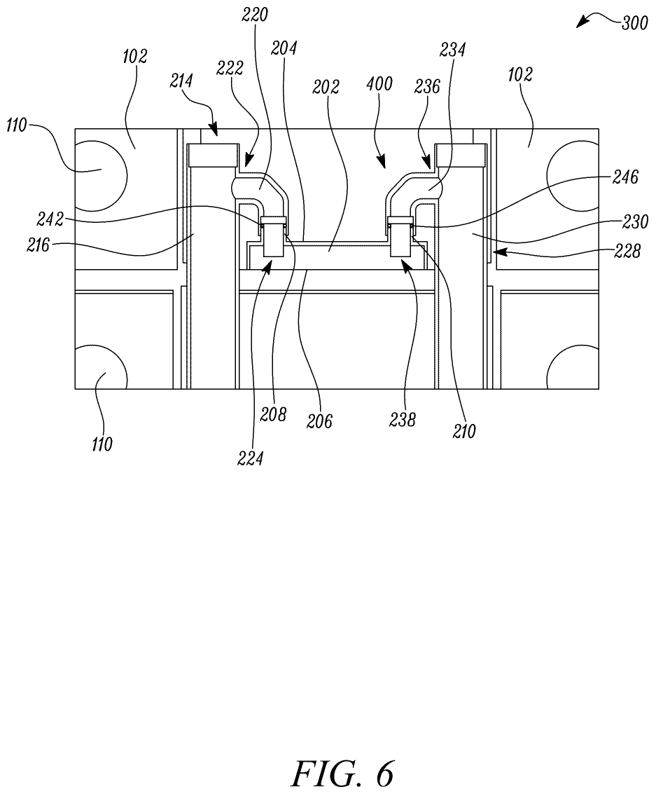

With reference to FIGS. 4 to 6, the cooling assembly 400 includes the inlet tube 220 and the outlet tube 234. The inlet tube 220 is fixedly coupled to the inlet manifold 214 and the inlet tube 220 is removably coupled to the cooling manifold 202. Each of the inlet tube 220 and the outlet tube 234 are removably coupled to the cooling manifold 202 at the top surface 204.

Further, the cooling assembly 400 includes the inlet connectors 208 and the outlet connectors 210. In the illustrated example of FIGS. 4 to 6, the inlet connector 208 and the outlet connector 210 of the cooling assembly 400 are disposed at the top surface 204 of the cooling manifold 202. Alternatively, the inlet connector 208 and the outlet connector 210 of the cooling assembly 400 may be disposed at the bottom surface 206 of the cooling manifold 202.

The first inlet end 222 of each inlet tube 220 is fixedly coupled to the inlet manifold 214. Further, the second inlet end 224 of each inlet tube 220 is removably coupled to the corresponding cooling manifold 202. Specifically, the second inlet end 224 of each inlet tube 220 is removably coupled to the corresponding cooling manifold 202 via the inlet connector 208. The second inlet end 224 of each inlet tube 220 is removably coupled to the corresponding cooling manifold 202 at the top surface 204. Further, each inlet connector 208 is removably coupled with the corresponding inlet tube 220 via the slip fit. Specifically, each inlet connector 208 is removably coupled with the corresponding inlet tube 220 via the O-ring slip joint. Further, the O-ring 242 is received within the O-ring groove 240 of the inlet connector 208 to seal the connection between the inlet tube 220 and the inlet connector 208. As illustrated herein, when coupled together, each inlet connector 208 is received within the corresponding inlet tube 220.

Furthermore, the first outlet end 236 of each outlet tube 234 is fixedly coupled to the outlet manifold 228. Moreover, the second outlet end 238 of each outlet tube 234 is removably coupled to the corresponding cooling manifold 202. Specifically, the second outlet end 238 of each outlet tube 234 is removably coupled to the corresponding cooling manifold 202 via the outlet connector 210. The second outlet end 238 of each outlet tube 234 is removably coupled to the corresponding cooling manifold 202 at the top surface 204. Further, each outlet connector 210 is removably coupled with the corresponding outlet tube 234 via the slip fit. Specifically, each outlet connector 210 is removably coupled with the corresponding outlet tube 234 via the O-ring slip joint. Further, the O-ring 246 is received within the O-ring groove 244 of the outlet connector 210 to seal the connection between the outlet tube 234 and the outlet connector 210. As illustrated herein, when coupled together, each outlet connector 210 is received within the corresponding outlet tube 234.

As shown in FIG. 4, each of the inlet manifold 214, the number of inlet tubes 220, the outlet manifold 228, and the number of outlet tubes 234 are offset from the vent portion 108 (see FIG. 5) of each of the number of battery modules 102.

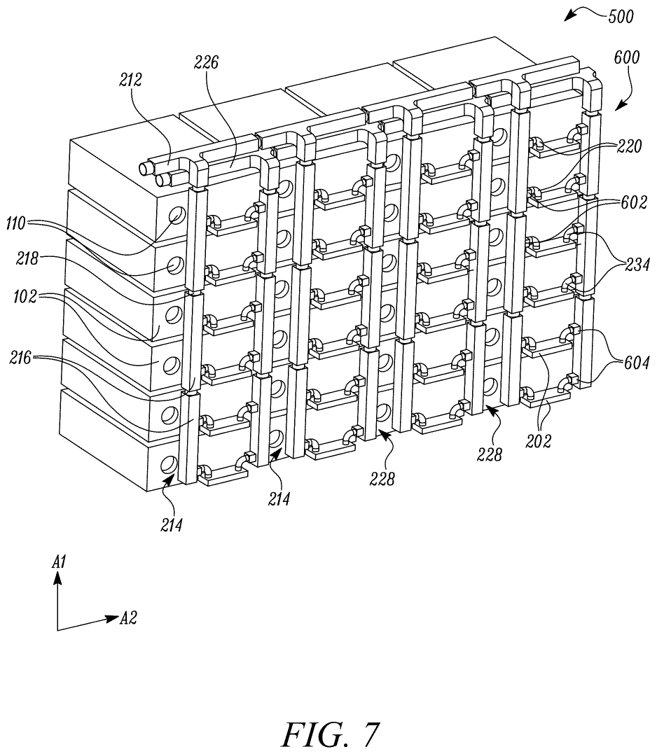

Referring to FIG. 7, a schematic perspective view of a battery system 500 is illustrated, according to yet another example of the present disclosure. The battery system 500 is substantially similar to the battery system 100 (see FIGS. 1 to 3), with common components being referred to by the same numerals. The battery system 500 includes a cooling assembly 600. The cooling assembly 600 is substantially similar to the cooling assembly 200 (see FIGS. 1 to 3), with common components being referred to by the same numerals. In the illustrated example of FIG. 7, each of the inlet channel 212 and the outlet channel 226 of the cooling assembly 600 is disposed proximal to the top end 104 of the battery system 500.

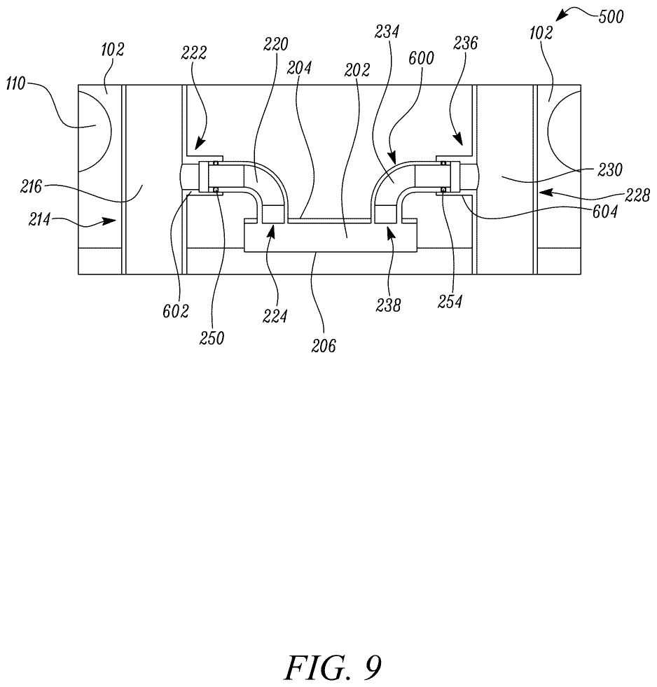

With reference to FIGS. 7 to 9, the cooling assembly 600 includes the inlet tube 220 and the outlet tube 234. The inlet tube 220 is removably coupled to the inlet manifold 214 and the inlet tube 220 is fixedly coupled to the cooling manifold 202. Specifically, the first inlet end 222 of each inlet tube 220 is removably coupled to the inlet manifold 214 and the second inlet end 224 of each inlet tube 220 is fixedly coupled to the corresponding cooling manifold 202. The second inlet end 224 of each inlet tube 220 is fixedly coupled to the corresponding cooling manifold 202 at the top surface 204.

The cooling assembly 600 further includes a number of inlet connectors 602. Each inlet connector 602 has a square outer shape and defines a circular through-hole. In the illustrated example of FIGS. 7 to 9, each inlet connector 602 from the number of inlet connectors 602 is fixedly coupled with the inlet manifold 214. In the illustrated example of FIGS. 7 to 9, each inlet connector 602 is removably coupled with the corresponding inlet tube 220 from the number of inlet tubes 220 to removably couple the corresponding inlet tube 220 with the inlet manifold 214. Each inlet connector 602 is removably coupled with the corresponding inlet tube 220 via an O-ring slip joint. Further, an O-ring 250 is received within an O-ring groove 248 defined in the inlet tube 220 at the first inlet end 222 of the inlet tube 220 to seal a connection between the inlet tube 220 and the inlet connector 602. Herein, the O-ring groove 248 is defined in the inlet tube 220 at its first inlet end 222 instead of the inlet connector 602. It should be noted that each inlet connector 602 may be removably coupled with the corresponding inlet tube 220 via any other type of fit. As illustrated herein, when coupled together, each inlet tube 220 is received within the corresponding inlet connector 602.

Further, the outlet tube 234 is removably coupled to the outlet manifold 228 and the outlet tube 234 is fixedly coupled to the cooling manifold 202. Specifically, the first outlet end 236 of each outlet tube 234 is removably coupled to the outlet manifold 228 and the second outlet end 238 of each outlet tube 234 is fixedly coupled to the corresponding cooling manifold 202. Further, the second outlet end 238 of each outlet tube 234 is fixedly coupled to the corresponding cooling manifold 202 at the top surface 204.

The cooling assembly 600 further includes a number of outlet connectors 604. Each outlet connector 604 has a square outer shape and defines a circular through-hole. In the illustrated example of FIGS. 7 to 9, each outlet connector 604 from the number of outlet connectors 604 is fixedly coupled with the outlet manifold 228. In the illustrated example of FIGS. 7 to 9, each outlet connector 604 is removably coupled with the corresponding outlet tube 234 from the number of outlet tubes 234 to removably couple the corresponding outlet tube 234 with the outlet manifold 228. Each outlet connector 604 is removably coupled with the corresponding outlet tube 234 via an O-ring slip joint. Further, an O-ring 254 is received within an O-ring groove 252 defined in the outlet tube 234 at the first outlet end 236 of the outlet tube 234 to seal a connection between the outlet tube 234 and the outlet connector 604. Herein, the O-ring groove 252 is defined in the outlet tube 234 at its first outlet end 236 instead of the outlet connector 604. It should be noted that each outlet connector 604 may be removably coupled with the corresponding outlet tube 234 via any other type of fit. As illustrated herein, when coupled together, each outlet tube 234 is received within the corresponding outlet connector 604.

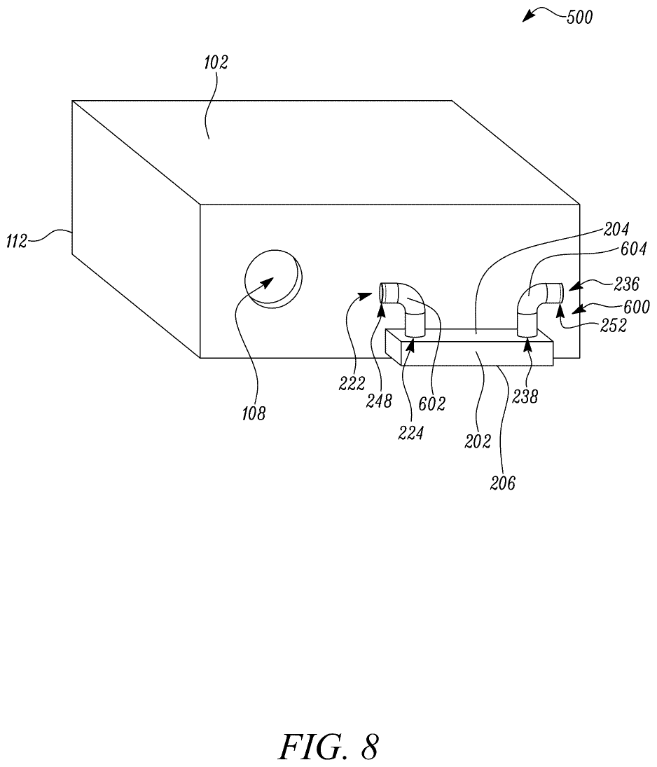

As shown in FIG. 7, each of the inlet manifold 214, the number of inlet tubes 220, the outlet manifold 228, and the number of outlet tubes 234 are offset from the vent portion 108 (see FIG. 8) of each of the number of battery modules 102.

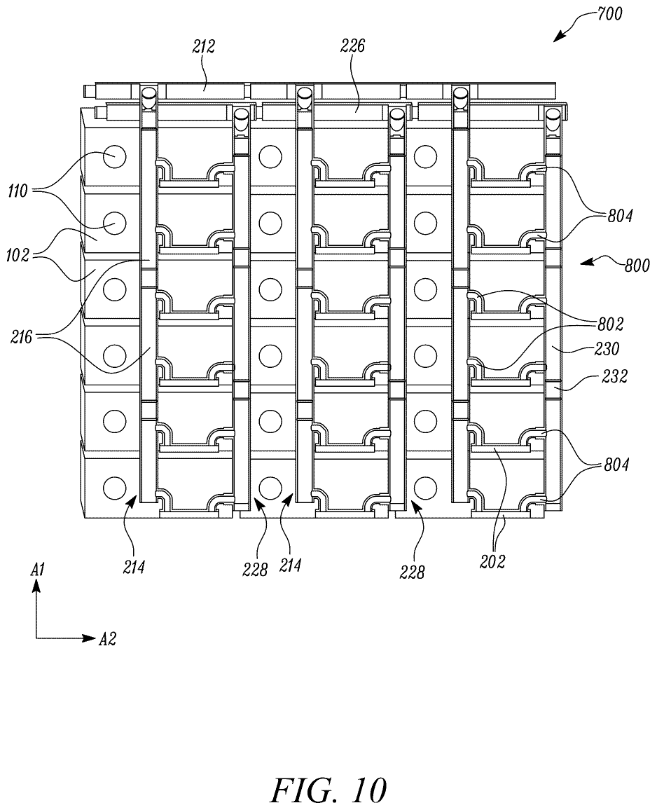

Referring to FIG. 10, a schematic perspective view of a battery system 700 is illustrated, according to yet another example of the present disclosure. The battery system 700 is substantially similar to the battery system 100 (see FIGS. 1 to 3), with common components being referred to by the same numerals. The battery system 700 includes a cooling assembly 800. The cooling assembly 800 is substantially similar to the cooling assembly 200 (see FIGS. 1 to 3), with common components being referred to by the same numerals. In the illustrated example of FIG. 10, each of the inlet channel 212 and the outlet channel 226 of the cooling assembly 800 is disposed proximal to the top end 104 of the battery system 700.

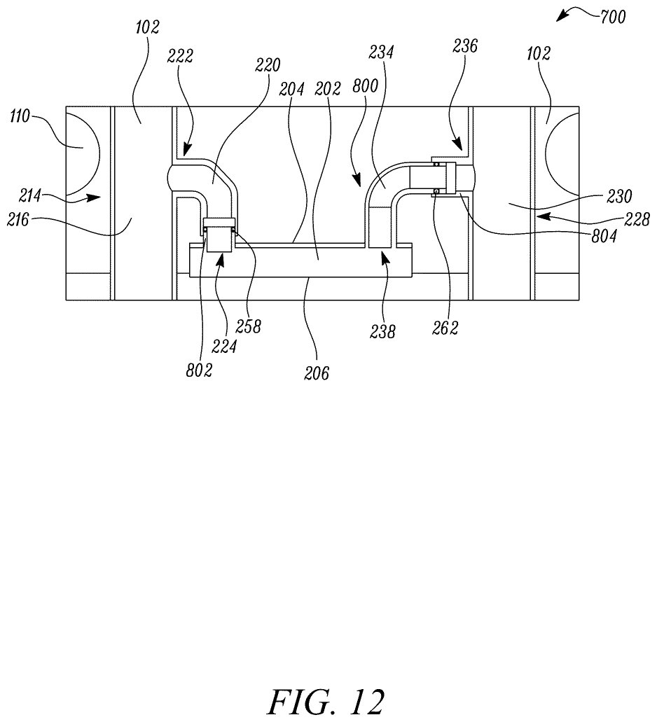

With reference to FIGS. 10 to 12, the cooling assembly 800 includes the inlet tube 220 and the outlet tube 234. The inlet tube 220 is fixedly coupled to the inlet manifold 214 and the inlet tube 220 is removably coupled to the cooling manifold 202. Specifically, the first inlet end 222 of each inlet tube 220 is fixedly coupled to the inlet manifold 214 and the second inlet end 224 of each inlet tube 220 is removably coupled to the corresponding cooling manifold 202. The second inlet end 224 of each inlet tube 220 is removably coupled to the corresponding cooling manifold 202 at the top surface 204.

The cooling assembly 800 further includes a number of inlet connectors 802. Each inlet connector 802 has a square outer shape and defines a circular through-hole. In the illustrated example of FIGS. 10 to 12, each inlet connector 802 from the number of inlet connectors 802 is fixedly coupled with the cooling manifold 202. In the illustrated example of FIGS. 10 to 12, each inlet connector 802 is removably coupled with the corresponding inlet tube 220 from the number of inlet tubes 220 to removably couple the corresponding inlet tube 220 with the corresponding cooling manifold 202. Each inlet connector 802 is removably coupled with the corresponding inlet tube 220 via an O-ring slip joint. Further, an O-ring 258 is received within the O-ring groove 256 of the inlet connector 802 to seal a connection between the inlet tube 220 and the inlet connector 802. It should be noted that each inlet connector 602 may be removably coupled with the corresponding inlet tube 220 via any other type of fit. As illustrated herein, when coupled together, each inlet connector 802 is received within the corresponding inlet tube 220.

Furthermore, the outlet tube 234 is removably coupled to the outlet manifold 228 and the outlet tube 234 is fixedly coupled to the cooling manifold 202. Specifically, the first outlet end 236 of each outlet tube 234 is removably coupled to the outlet manifold 228 and the second outlet end 238 of each outlet tube 234 is fixedly coupled to the corresponding cooling manifold 202. Further, the second outlet end 238 of each outlet tube 234 is fixedly coupled to the corresponding cooling manifold 202 at the top surface 204.

The cooling assembly 800 further includes a number of outlet connectors 804. Each outlet connector 804 has a square outer shape and defines a circular through-hole. In the illustrated example of FIGS. 10 to 12, each outlet connector 804 from the number of outlet connectors 804 is fixedly coupled with the corresponding outlet manifold 228. In the illustrated example of FIGS. 10 to 12, each outlet connector 804 is removably coupled with the corresponding outlet tube 234 from the number of outlet tubes 234 to removably couple the corresponding outlet tube 234 with the outlet manifold 228. Each outlet connector 804 is removably coupled with the corresponding outlet tube 234 via an O-ring slip joint. Further, an O-ring 262 is received within an O-ring groove 260 defined the outlet tube 234 at the first outlet end 236 of the outlet tube 234 to seal a connection between the outlet tube 234 and the outlet connector 804. Herein, the O-ring groove 260 is defined in the outlet tube 234 at its first outlet end 236 instead of the outlet connector 804. It should be noted that each outlet connector 804 may be removably coupled with the corresponding outlet tube 234 via any other type of fit. As illustrated herein, when coupled together, each outlet tube 234 is received within the corresponding outlet connector 804.

In an alternate example, the inlet tube 220 may be removably coupled with the inlet manifold 214 and the inlet tube 220 may be fixedly coupled with the cooling manifold 202. In an alternate example, the outlet tube 234 may be fixedly coupled with the outlet manifold 228 and the outlet tube 234 may be removably coupled with the cooling manifold 202.

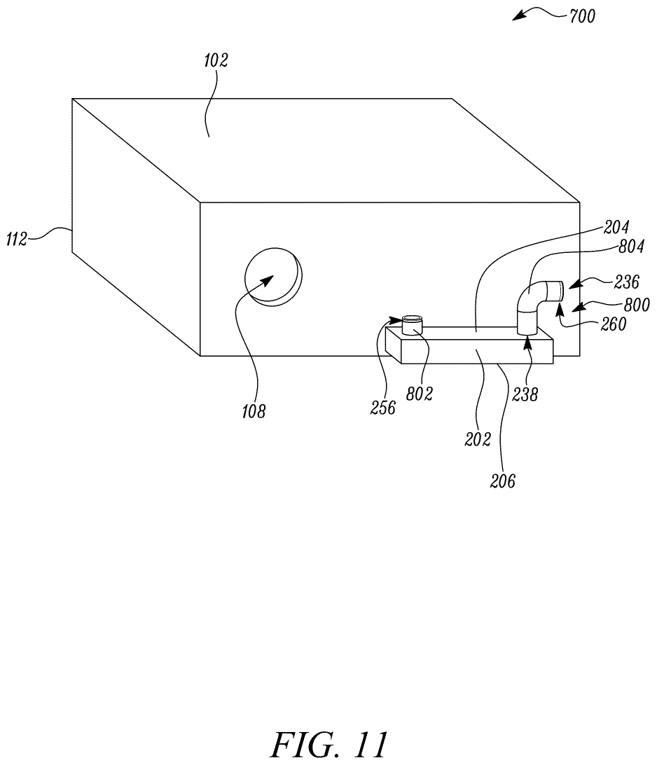

As shown in FIG. 10, each of the inlet manifold 214, the number of inlet tubes 220, the outlet manifold 228, and the number of outlet tubes 234 are offset from the vent portion 108 (see FIG. 11) of each of the number of battery modules 102.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the cooling assembly 200, 400, 600, 800 for the battery system 100, 300, 500, 700. The cooling assembly 200, 400, 600, 800 includes the number of cooling manifolds 202. The cooling assembly 200, 400, 600, 800 also includes the inlet channel 212 and the outlet channel 226 for allowing ingress and egress, respectively, of the cooling fluid. In one example, the inlet channel 212 may be disposed at the bottom end 106 and the outlet channel 226 may be disposed at the top end 104, which may allow for bottom fill and drain capability as well as top venting capability. Alternatively, the inlet channel 212 and the outlet channel 226 may be disposed at the top end 104.

Further, the cooling assembly 200, 400, 600, 800 includes the inlet manifold 214 and the outlet manifold 228. The inlet manifold 214 includes the inlet manifold portions 216 and the inlet coupling portion 218, and the outlet manifold 228 includes the outlet manifold portions 230 and the outlet coupling portion 232. Such a design of the inlet manifold 214 and the outlet manifold 228 may provide a number of break points and slip capability to absorb tolerance stack up of the number of battery modules 102. Further, components of the cooling assembly 200, 400, 600, 800 may be easy to service, repair, or replace, as only a small section of the components may have to be removed instead of dismantling the entire cooling assembly 200, 400, 600, 800.

Moreover, the cooling assembly 200, 400, 600, 800 also includes the number of inlet connectors 208, 602, 802 which are removably coupled with the corresponding inlet tube 220, and the number of outlet connectors 210, 604, 804 which are removably coupled with the corresponding outlet tube 234. The inlet connectors 208, 602, 802 removably couple the corresponding inlet tube 220 with any one of the inlet manifold 214 and the corresponding cooling manifold 202. The outlet connectors 210, 604, 804 removably couple the corresponding outlet tube 234 with any one of the outlet manifold 228 and the corresponding cooling manifold 202. The removable coupling may improve flexibility in the cooling assembly 200, 400, 600, 800 during construction, maintenance, and replacement of one or more components of the cooling assembly 200, 400, 600, 800.

Further, coupling of the inlet and outlet tubes 220, 234 with the corresponding inlet connectors 208, 602, 802 and the outlet connectors 210, 604, 804 are facilitated by the O-ring slip joints, which may allow easy manufacturing and assembly, may provide a slip capability during an assembly process of the cooling assembly 200, 400, 600, 800, and may allow two or more battery systems to be assembled together. Further, the inlet connectors 208, 602, 802 and the outlet connectors 210, 604, 804 including the O-ring slip joints have less potential to develop leaks over time as compared to conventional cooling hoses.

Furthermore, all components of the cooling assembly 200, 400, 600, 800 are offset from the burst disc 110, and thus the components do not lie directly in a path of thermal runaway gases that may exit the battery modules 102. This feature may prevent the components of the cooling assembly 200, 400, 600, 800 from direct interaction with the thermal runaway gases. Moreover, the inlet manifolds 214, the inlet tubes 220, the cooling manifolds 202, the outlet manifolds 228, and the outlet tubes 234 may be made of metals or alloys, which may be robust against the high-temperature thermal runaway gases and may prevent leaks from the cooling assembly 200, 400, 600, 800. Furthermore, various components of the cooling assembly 200, 400, 600, 800, such as, the inlet connectors 208, 602, 802 and the outlet connectors 210, 604, 804 may be less susceptible to wear as compared to conventional cooling hoses.

The cooling assembly 200, 400, 600, 800 described herein is less susceptible to leaks due to assembly variation. Overall, the cooling assembly 200, 400, 600, 800 may have a robust design, may be simple in construction, may be cost-effective, and may be durable. Further, the cooling assembly 200, 400, 600, 800 may be retrofitted on existing battery systems. Moreover, the cooling assembly 200, 400, 600, 800 may be used on a variety of the battery systems.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

1. A cooling assembly for a battery system, the battery system including a plurality of battery modules, the cooling assembly comprising:
a plurality of cooling manifolds, wherein each cooling manifold from the plurality of cooling manifolds is in fluid communication with a corresponding battery module from the plurality of battery modules;
an inlet channel for allowing ingress of a cooling fluid into the cooling assembly;
an inlet manifold fluidly coupled with the inlet channel and extending along a vertical axis of the battery system;
a plurality of inlet tubes, wherein each inlet tube from the plurality of inlet tubes fluidly communicates the inlet manifold with a corresponding cooling manifold from the plurality of cooling manifolds, wherein each inlet tube defines a first inlet end and a second inlet end, and wherein the first inlet end of each inlet tube is coupled to the inlet manifold and the second inlet end of each inlet tube is coupled to the corresponding cooling manifold;
an outlet channel for allowing egress of the cooling fluid from the cooling assembly;
an outlet manifold fluidly coupled with the outlet channel and extending along the vertical axis of the battery system; and
a plurality of outlet tubes, wherein each outlet tube from the plurality of outlet tubes fluidly communicates the corresponding cooling manifold with the outlet manifold, wherein each outlet tube defines a first outlet end and a second outlet end, wherein the first outlet end of each outlet tube is coupled to the outlet manifold and the second outlet end of each outlet tube is coupled to the corresponding cooling manifold, and wherein each of the inlet manifold, the plurality of inlet tubes, the outlet manifold, and the plurality of outlet tubes are offset from a vent portion of each of the plurality of battery modules.

2. The cooling assembly of claim 1, wherein the first inlet end of each inlet tube is fixedly coupled to the inlet manifold, and wherein the second inlet end of each inlet tube is removably coupled to the corresponding cooling manifold.

3. The cooling assembly of claim 1, wherein the first inlet end of each inlet tube is removably coupled to the inlet manifold, and wherein the second inlet end of each inlet tube is fixedly coupled to the corresponding cooling manifold.

4. The cooling assembly of claim 1, wherein the first outlet end of each outlet tube is fixedly coupled to the outlet manifold, and wherein the second outlet end of each outlet tube is removably coupled to the corresponding cooling manifold.

5. The cooling assembly of claim 1, wherein the first outlet end of each outlet tube is removably coupled to the outlet manifold, and wherein the second outlet end of each outlet tube is fixedly coupled to the corresponding cooling manifold.

6. The cooling assembly of claim 1, wherein each cooling manifold defines a top surface and a bottom surface, wherein the second inlet end of each inlet tube is coupled to the corresponding cooling manifold at any one of the top surface and the bottom surface, and wherein the second outlet end of each outlet tube is coupled to the corresponding cooling manifold at any one of the top surface and the bottom surface.

7. The cooling assembly of claim 1, wherein the inlet channel is disposed proximal to a bottom end of the battery system and the outlet channel is disposed proximal to a top end of the battery system.

8. The cooling assembly of claim 1, wherein each of the inlet channel and the outlet channel is disposed proximal to a top end of the battery system.

9. The cooling assembly of claim 1, wherein the inlet manifold includes a plurality of inlet manifold portions and a plurality of inlet coupling portions, and wherein each inlet coupling portion connects two inlet manifold portions with each other.

10. The cooling assembly of claim 1, wherein the outlet manifold includes a plurality of outlet manifold portions and a plurality of outlet coupling portions, and wherein each outlet coupling portion connects two outlet manifold portions with each other.

11. The cooling assembly of claim 1 further comprising:
a plurality of inlet connectors, wherein each inlet connector from the plurality of inlet connectors is fixedly coupled to any one of the inlet manifold and the corresponding cooling manifold, and wherein each inlet connector is removably coupled with a corresponding inlet tube from the plurality of inlet tubes to removably couple the corresponding inlet tube with any one of the inlet manifold and the corresponding cooling manifold; and
a plurality of outlet connectors, wherein each outlet connector from the plurality of outlet connectors is fixedly coupled to any one of the outlet manifold and the corresponding cooling manifold, and wherein each outlet connector is removably coupled with a corresponding outlet tube from the plurality of outlet tubes to removably couple the corresponding outlet tube with any one of the outlet manifold and the corresponding cooling manifold.

12. The cooling assembly of claim 11, wherein each inlet connector is removably coupled with the corresponding inlet tube via a slip fit, and wherein each outlet connector is removably coupled with the corresponding outlet tube via a slip fit.

13. A battery system comprising:
a plurality of battery modules; and
a cooling assembly to direct a cooling fluid towards the plurality of battery modules, the cooling assembly including:
a plurality of cooling manifolds, wherein each cooling manifold from the plurality of cooling manifolds is in fluid communication with a corresponding battery module from the plurality of battery modules;
an inlet channel for allowing ingress of the cooling fluid into the cooling assembly;
an inlet manifold fluidly coupled with the inlet channel and extending along a vertical axis of the battery system;
a plurality of inlet tubes, wherein each inlet tube from the plurality of inlet tubes fluidly communicates the inlet manifold with a corresponding cooling manifold from the plurality of cooling manifolds, wherein each inlet tube defines a first inlet end and a second inlet end, and wherein the first inlet end of each inlet tube is coupled to the inlet manifold and the second inlet end of each inlet tube is coupled to the corresponding cooling manifold;
an outlet channel for allowing egress of the cooling fluid from the cooling assembly;
an outlet manifold fluidly coupled with the outlet channel and extending along the vertical axis of the battery system; and
a plurality of outlet tubes, wherein each outlet tube from the plurality of outlet tubes fluidly communicates the corresponding cooling manifold with the outlet manifold, wherein each outlet tube defines a first outlet end and a second outlet end, wherein the first outlet end of each outlet tube is coupled to the outlet manifold and the second outlet end of each outlet tube is coupled to the corresponding cooling manifold, and wherein each of the inlet manifold, the plurality of inlet tubes, the outlet manifold, and the plurality of outlet tubes are offset from a vent portion of each of the plurality of battery modules.

14. The battery system of claim 13, wherein:
the first inlet end of each inlet tube is fixedly coupled to the inlet manifold, wherein the second inlet end of each inlet tube is removably coupled to the corresponding cooling manifold; or
the first inlet end of each inlet tube is removably coupled to the inlet manifold, wherein the second inlet end of each inlet tube is fixedly coupled to the corresponding cooling manifold.

15. The battery system of claim 13, wherein:
the first outlet end of each outlet tube is fixedly coupled to the outlet manifold, wherein the second outlet end of each outlet tube is removably coupled to the corresponding cooling manifold; or
the first outlet end of each outlet tube is removably coupled to the outlet manifold, wherein the second outlet end of each outlet tube is fixedly coupled to the corresponding cooling manifold.

16. The battery system of claim 13, wherein each cooling manifold defines a top surface and a bottom surface, wherein the second inlet end of each inlet tube is coupled to the corresponding cooling manifold at any one of the top surface and the bottom surface, and wherein the second outlet end of each outlet tube is coupled to the corresponding cooling manifold at any one of the top surface and the bottom surface.

17. The battery system of claim 13, wherein the inlet manifold includes a plurality of inlet manifold portions and a plurality of inlet coupling portions, and wherein each inlet coupling portion connects two inlet manifold portions with each other.

18. The battery system of claim 13, wherein the outlet manifold includes a plurality of outlet manifold portions and a plurality of outlet coupling portions, and wherein each outlet coupling portion connects two outlet manifold portions with each other.

19. The battery system of claim 13, wherein the cooling assembly further includes:
a plurality of inlet connectors, wherein each inlet connector from the plurality of inlet connectors is fixedly coupled to any one of the inlet manifold and the corresponding cooling manifold, and wherein each inlet connector is removably coupled with a corresponding inlet tube from the plurality of inlet tubes to removably couple the corresponding inlet tube with any one of the inlet manifold and the corresponding cooling manifold; and
a plurality of outlet connectors, wherein each outlet connector from the plurality of outlet connectors is fixedly coupled to any one of the outlet manifold and the corresponding cooling manifold, and wherein each outlet connector is removably coupled with a corresponding outlet tube from the plurality of outlet tubes to removably couple the corresponding outlet tube with any one of the outlet manifold and the corresponding cooling manifold.

20. The battery system of claim 13, wherein:
the inlet channel is disposed proximal to a bottom end of the battery system and the outlet channel is disposed proximal to a top end of the battery system; or
each of the inlet channel and the outlet channel is disposed proximal to the top end of the battery system.
